(19) United States
(12) Patent Application Publication
(10) Pub. No.: US 2024/0273585 A1
(43) Pub. Date: Aug. 15, 2024

(54) SUPPLIER VIRTUOUS CYCLE EVALUATION METHOD BASED ON ON-SITE VERIFICATION

(71) Applicant: Moon Kwan PARK, Seoul (KR)

(72) Inventor: Moon Kwan PARK, Seoul (KR)

(21) Appl. No.: 18/684,363

(22) PCT Filed: Aug. 16, 2022
(86) PCT No.: PCT/KR2022/012159

§ 371 Date: Feb. 16, 2024

(30) Foreign Application Priority Data
Aug. 16, 2021 (KR) 10-2021-0107758
Aug. 12, 2022 (KR) 10-2022-0101409

(51) Int. Cl. G06Q 30/0282; G06Q 30/0217

(52) U.S. Cl. CPC G06Q 30/0282; G06Q 30/0217

(57) ABSTRACT

A supplier virtuous cycle evaluation method based on on-site verification is disclosed. The method comprises the steps of: a mobile application, executed on a mobile terminal of a user, acquiring store information including a store location from a store that supplies a tangible or intangible product; the mobile application granting the user evaluation authority over the corresponding store if a location of the mobile terminal matches the store location and the corresponding store is a pre-registered store; the mobile application uploading, to a management server, the result of evaluation of the store according to evaluation by the user who has been granted the evaluation authority; the management server paying and managing a reward to the user before or after the evaluation of the store by the user who has been granted the evaluation authority; and the management server providing a store promotion service for disclosing the uploaded result of the evaluation of the store online.

### TECHNICAL FIELD

The present disclosure relates to a technology of providing a service using a mobile application and, more particularly, to a technology of providing a service for the mutual benefit between consumers and suppliers.

### BACKGROUND ART

Korean Patent No. 10-20304627 discloses a reward system for encouraging visits to offline stores. This system prioritizes a reward in each offline store, provides a certain amount of rewards when a user visits an offline store and authenticates a purchase with the purchase receipt received from a purchase of a product, and allows the rewards to be used at various purchasing locations, thereby encouraging users to visit offline stores and helping to improve the store's sales.

### DISCLOSURE

### Technical Problem

An objective of the present disclosure is to provide a method that allows users (consumers) to voluntarily evaluate stores (suppliers) and accordingly promote stores in a virtuous cycle.

### Technical Solution

A supplier virtuous cycle evaluation method based on on-site verification according to an exemplary aspect may include a step in which a mobile application executed on a user's mobile terminal acquires a store information, including a store location, in a store that supplies tangible or intangible products, a step in which the mobile application grants the user the right to evaluate the corresponding store when the location of the mobile terminal matches the store location and the corresponding store is a pre-registered store, a step in which the mobile application uploads to a management server store evaluation results by the user to which the evaluation authority is granted, a step in which the management server pays and manages rewards to the user before or after the evaluation of the user to which the evaluation authority is granted, and a step in which the management server provides a store promotion service that makes the uploaded store evaluation results available online.

The supplier virtuous cycle evaluation method based on on-site verification may further include a step in which the mobile application receives a choice between an immediate evaluation and a scheduled evaluation from the user to which the evaluation authority is granted, a step in which the mobile application provides a user interface for store evaluation to the user when the user selects the immediate evaluation, and a step in which the mobile application provides a user interface for store evaluation to the user only within a certain period of time when the user selects the scheduled evaluation. When the scheduled evaluation is selected, the reward payment step may pay rewards before the store evaluation.

The supplier virtuous cycle evaluation method based on on-site verification may further include a step in which the management server imposes a penalty on the user when the store evaluation results are not uploaded within a certain period of time when the scheduled evaluation is selected.

### Advantageous Effects

The present disclosure may create effects of securing the reliability of users' store evaluations, enabling an active virtuous cycle of evaluation and promotion by encouraging users to participate in the evaluations, and securing reliability in store evaluations.

### DESCRIPTION OF DRAWINGS

FIG. 1 is a block diagram of a supplier virtuous cycle evaluation method based on on-site verification according to an exemplary embodiment.

FIG. 2 is a block diagram of a mobile terminal according to an exemplary embodiment.

FIGS. 3 and 4 are flowcharts performed in a mobile terminal according to an exemplary embodiment.

FIG. 5 is a flowchart performed in a management server according to an exemplary embodiment.

FIG. 6 is a flowchart performed in a management server according to another exemplary embodiment.

FIG. 7 is an exemplary diagram of a computing device configuration for a server.

### MODE FOR INVENTION

The above-described and additional aspects of the present disclosure will become more apparent through the preferred exemplary embodiments described with reference to the accompanying drawings. Hereinafter, the present disclosure will be described in detail so that those skilled in the art may easily understand and reproduce the present disclosure through such exemplary embodiments.

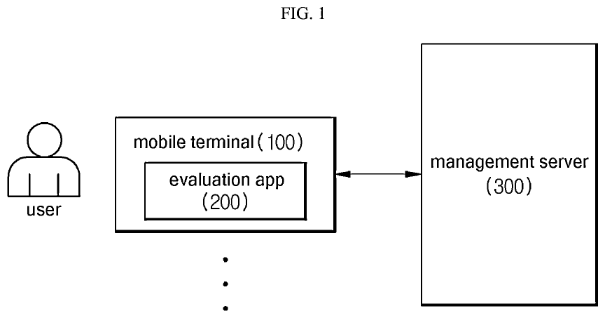

FIG. 1 is a block diagram of a supplier virtuous cycle evaluation method based on on-site verification according to an exemplary embodiment. A mobile terminal 100 may be a communicable computing device carried by a user (a consumer), and may include a smartphone as an example. A mobile application 200 (hereinafter, referred to as an ‘evaluation app’) for the supplier evaluation based on on-site verification may be installed and executed in the mobile terminal 100. Herein The user may refer to a consumer who purchases a product by visiting a store (supplier) that sells (supplies) tangible or intangible products.

A management server 300 may be a server system that includes one or more computing devices for servers and may be operated under various operating systems, including but not limited to, Windows-based operating systems, MacOS, Java, Unix, or Linux. Such a management server 300 may communicate data with the mobile terminal 100, more specifically store in a database and manage store evaluation results performed by users through interworking with the evaluation apps 200, and provide a store promotion service that makes available online to users via the web or an app the store evaluation results and promotes a store.

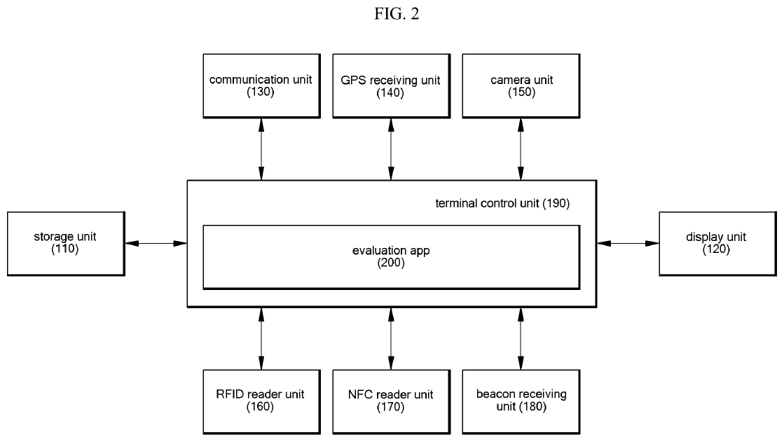

FIG. 2 is a block diagram of a mobile terminal according to an exemplary embodiment. The mobile terminal 100 may include at least one of a storage unit 110, a display unit 120, a communication unit 130, a GPS receiving unit 140, a camera unit 150, an RFID reader unit 160, an NFC reader unit 170, a beacon receiving unit 180, and a terminal control unit 190. The storage unit 110 may store commands, data, programs and the like for operating the mobile terminal 100, and the evaluation app 200 may also be recorded and managed in the form of a program code. The display unit 120 may provide a screen that allows a user to use the evaluation app 200, and may be not only an output screen but also a touch screen capable of receiving an input from the user. The communication unit 130 may be a communication module for transmitting and receiving data to and from the management server 300, and the GPS receiving unit 140 may be a receiver that receives a GPS signal from a global positioning system (GPS) satellite, which is already well known.

The camera unit 150, the RFID reader unit 160, the NFC reader unit 170, and the beacon receiving unit 180 may be also well known in themselves and may be used in the present disclosure as a means for acquiring the store information from barcodes such as QR (Quick Response) codes, RFID tags, NFC tags, or beacons provided in stores. That is, the store information may be recorded in a QR code, a RFID (Radio Frequency Identification) tag, or a NFC (Near Field Communication) tag and the like provided in the store and may be acquired through the camera unit 150, the RFID reader unit 160, or the NFC reader unit 170, and wireless transmission signals of a beacon installed in the store may be received through the beacon receiving unit 180, and the store information may be acquired from the received signal. The above is just exemplary, and the store information may be acquired through other known means or new means that may appear in the future.

The terminal control unit 190 may control overall the mobile terminal 100 and may include one or more processors. A processor of the terminal control unit 190 may load and execute the evaluation app 200 stored in the storage unit 110, so that the user may use the evaluation app 200, evaluate the store visited in person using the evaluation app 200, upload the evaluation information to the management server 300, and check the evaluation information for each store available on the online platform of the management server 300.

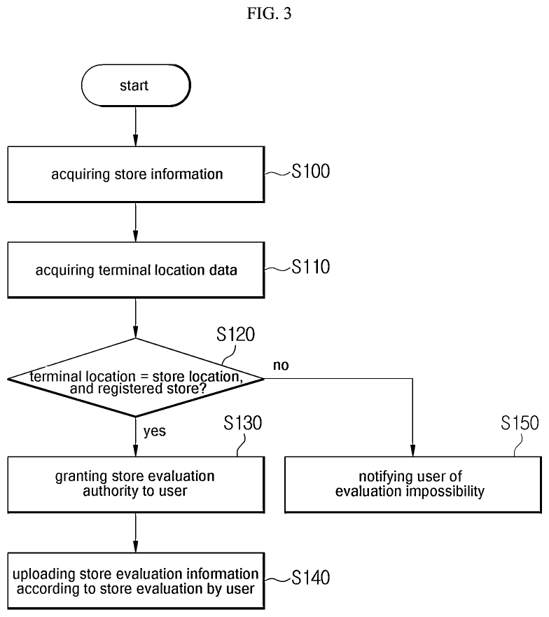

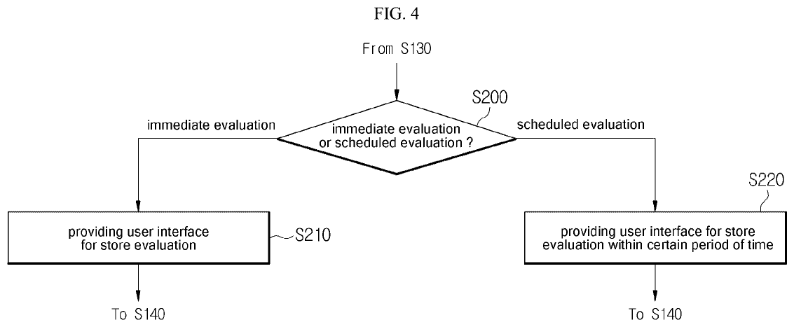

Hereinafter, exemplary embodiments of a supplier virtuous cycle evaluation method based on on-site verification will be described with reference to FIGS. 3 to 6. FIGS. 3 and 4 are flowcharts performed by the evaluation app 200 executed on the mobile terminal, and FIG. 5 is a flowchart performed in the management server. However, this may not mean that the evaluation app 200 and the management server 300 perform the steps independently and at least some steps may be performed in conjunction with each other.

FIG. 3 will be described. The evaluation app 200 may acquire a store information using a hardware resource of the mobile terminal 100 (S100). In this case, the hardware resource to be used may be a camera unit 150, an RFID reader unit 160, an NFC reader unit 170, a beacon receiver 180, or something else. The store information may include store location data, and may also include store identification information such as a store name (a supplier name). The evaluation app 200 may also acquire location data of the mobile terminal 100 (S110). In this case, the hardware resource to be used may be the GPS receiver 140, but is not limited thereto. The step S110 may be a step that is subsequently performed after the step S100 is first performed, or a step before the step S100, or the steps S100 and S110 may be performed independently regardless of the order.

The evaluation app 200 may compare and check whether the store location identified through the store information in the step S100 matches the terminal location in the step S110 (S120). That is, it may compare and check whether the terminal location is within the store location. In this case, considering errors of the terminal location, it may be possible to compare and check whether the terminal location matches the store location within a predetermined error range. In addition, the evaluation app 200 may determine whether the corresponding store is a registered store in S120. In an exemplary embodiment, the management server 300 may manage information on registered stores in a database in advance and the evaluation app 200 may inquire the management server 300 using a store identification information in the store information about whether the store is a registered store and determine whether the store is registered or not.

In S120 when it is confirmed that the terminal location matches the store location and the user is located in the store and it is confirmed that the corresponding store is a registered store, the evaluation app 200 grants the user the evaluation authority for the corresponding store (S130). Accordingly, the user may proceed to evaluate the store visited on-site through the evaluation app 200 and the evaluation app 200 may upload to the management server 300 the store evaluation information acquired from the user's evaluation (S140). Meanwhile, in S120 when the terminal location is different from the store location or when it is confirmed that the corresponding store is not a registered store, the evaluation app 200 may notify the user that the evaluation is not possible (S150).

FIG. 4 will be described. FIG. 4 may be a procedure performed between S130 and S140 of FIG. 3. The evaluation app 200 may allow the user to which the evaluation authority is granted to select whether to do an immediate evaluation or a scheduled evaluation with respect to the store (S200), may provide a user interface for store evaluation to the user so that the user performs a store evaluation when the user selects the immediate evaluation (S210), or may grant the user a certain period of time from the time when the user is granted evaluation rights for the store evaluation when the user selects the scheduled evaluation and may provide a user interface for the store evaluation so that the user performs the store evaluation anytime when there is a user's request within the granted certain period of time (S220).

Meanwhile, as shown in FIG. 4, the user may not be able to choose between the immediate evaluation or the scheduled evaluation, but may be forced to choose one or the other without selection. That is, the user to which the evaluation authority is granted may have to immediately perform an evaluation or may only perform an evaluation within a given period of time.

FIG. 5 will be described. FIG. 5 may be performed in the case of the immediate evaluation described above. The management server 300 may receive the store evaluation information uploaded from the evaluation app 200 and may store and manage the received store evaluation information in a database (S300). The management server 300 may pay a reward to the user as compensation for the store evaluation, and pay the rewards to the user through the evaluation app 200 (S310). The rewards may be a coupon or point that can be used like cash in the corresponding store, but is not limited thereto. Also, the management server 300 may provide a store promotion service that makes available online to the users through a web page or an app the store evaluation information which is managed in a database (S320).

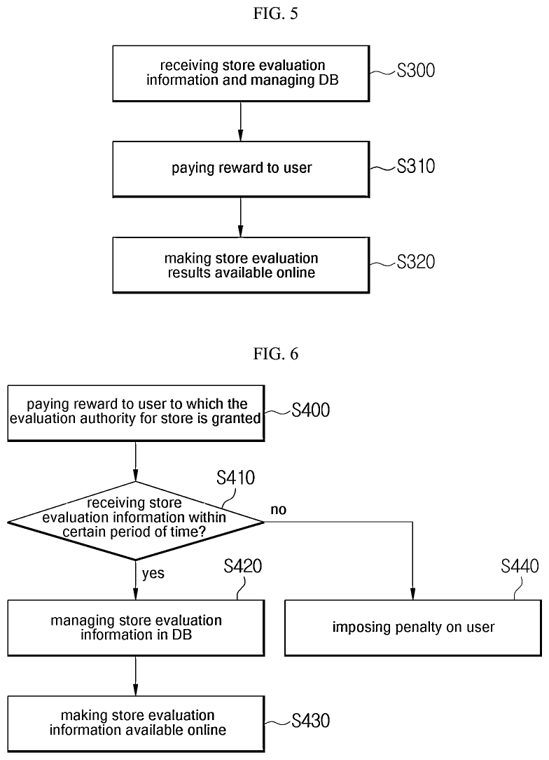

FIG. 6 will be described. FIG. 6 may be performed in the case of the scheduled evaluation described above. The management server 300 may pay rewards to the user to which the evaluation authority for a store is granted (S400). The rewards may be the same as described above. When the store evaluation information is received from the evaluation app 200 within the predetermined period granted to the user, the management server 300 may store and manage the received store evaluation information in a database (S410)(S420). Also, the management server 300 may provide a store promotion service that makes available online through a web page or an app the store evaluation information which is managed in the database (S430). Meanwhile, when the store evaluation information is not received within the predetermined period, that is, when the store evaluation information is not uploaded from the evaluation app 200, the management server 300 may impose a penalty on the user (S440). The penalty may be to restrict the user's ability to use the evaluation app 200, to downgrade the user's membership in the case of a membership system, or to reclaim the rewards paid. These penalties are exemplary, and the manner of the penalty is not particularly limited.

According to the above, it is possible to prevent evaluation manipulation by malicious users who have not visited on-site since the store evaluation is performed only by users who are authenticated to visit the store, thereby increasing the reliability of the evaluation, and the voluntary participation of visitors and accordingly the promotion of the store may be achieved in a virtuous cycle.

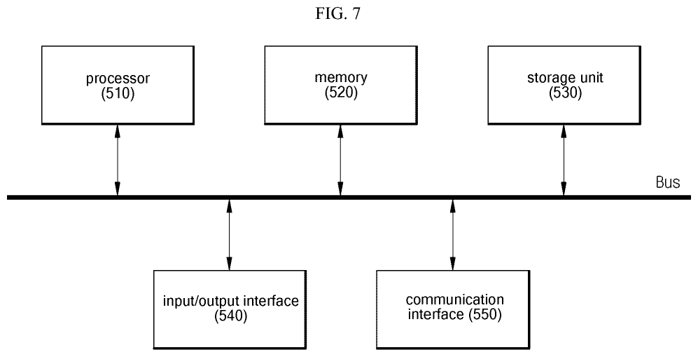

FIG. 7 is an exemplary diagram of a computing device configuration for a server. A method performed by a management server may be performed by one or more computing devices for servers, and specifically be performed by one or more processors belonging to computing devices. As shown in FIG. 7, a computing device 500 may include a processor 510, a memory 520, a storage unit 530, an input/output interface 540, and a communication interface 550. The processor 510 may include a central processing unit (CPU), a graphic processing unit (GPU) or a microprocessor including one or more processing cores similar thereto. Memory 520 may store data and programs for execution by processor 510. The memory 520 may include one or more volatile and nonvolatile memories, and may be internal or distributed memories. The storage unit 530 may be for a database and may include non-transitory storages. The storage unit 530 may include at least some of a hard disk drive, a flash memory, an optical disk, a magnetic-optical disk, a universal serial bus (USB) drive, and the like.

The input/output interface 540 may enable a user to provide input and receive output and may include one or more input and/or output devices that send and receive data to and from other computing devices. The input/output interface 540 may be a mouse, keypad or keyboard, camera, optical scanner, network interface, modem, or other known I/O device, and may include a combination thereof. The input/output interface 540 may include at least some of a graphic engine, a display, one or more output drivers (e.g., display driver), one or more audio speakers, and one or more audio drivers. The communication interface 550 may provide one or more interfaces for network communication (e.g., packet-based communication) between the computing device 500 and one or more other computing devices. For example, the communication interface 550 may include a network interface controller (NIC) or a network adapter for communicating with Ethernet or other wired based networks, or a wireless NIC or wireless adapter for communicating over a wireless network, such as Wi-Fi.

Meanwhile, a bus may include hardware, software, or both that connect components of a computing device to each other. For example, a bus may include an accelerated graphics port (AGP) or other graphics bus, an enhanced industry standard architecture (EISA) bus, a front-side bus (FSB), a hypertransport (HT) interconnect, an industry standard architecture (ISA) bus, an INFINIBAND interconnect, a low-pin-count (LPC) bus, a memory bus, a micro channel architecture (MAC) bus, a peripheral component interconnect (PCI) bus, a PCIe (PCI-Express) bus, a serial technology attachment (SATA) bus, a VL (VESA Local, VESA: Video Electronics Standard Association Local) bus, other suitable buses or combinations thereof. The above configurations of FIG. 7 are exemplary, and the computing device may include at least some of the configurations of FIG. 7 and may include other configurations not shown.

So far, the present disclosure has been described focusing on the preferred exemplary embodiments. A person skilled in the art to which the present disclosure pertains will understand that the present disclosure may be implemented in a modified form without departing from the essential characteristics of the present disclosure. Therefore, the disclosed exemplary embodiments should be considered from an illustrative rather than a restrictive perspective. The scope of the present disclosure is shown in the claims, not the above description, and all differences within the scope of equivalents are to be construed as being included in the present disclosure.

1. A supplier virtuous cycle evaluation method based on on-site verification, the method comprising:
a step in which a mobile application executed on a user's mobile terminal acquires a store information, including a store location, in a store that supplies tangible or intangible products;
a step in which the mobile application grants the user a right to evaluate the corresponding store when a location of the mobile terminal matches the store location and the corresponding store is a pre-registered store;
a step in which the mobile application uploads to a management server store evaluation results by the user to which an evaluation authority is granted;
a step in which the management server pays and manages a reward to the user before or after the store evaluation of the user to which the evaluation authority is granted; and
a step in which the management server provides a store promotion service that makes the uploaded store evaluation results publicly available online.

2. The method of claim 1, wherein the step of acquiring store information acquires the store information by scanning a barcode where the store information is recorded or wirelessly acquires the store information from a device in the store.

3. The method of claim 1, further comprising:
a step in which the mobile application receives a choice between an immediate evaluation and a scheduled evaluation from the user to which the evaluation authority is granted;
a step in which the mobile application provides a user interface for the store evaluation to the user when the user selects the immediate evaluation; and
a step in which the mobile application provides a user interface for the store evaluation to the user only within a certain period of time when the user selects the scheduled evaluation,
wherein the reward payment step pays the reward after the store evaluation when the immediate evaluation is selected and pays the reward before the store evaluation when the scheduled evaluation is selected.

4. The method of claim 3, further comprising:
a step in which the management server imposes a penalty on the user when the store evaluation results are not uploaded within a certain period of time when the scheduled evaluation is selected

5. The method of claim 3, further comprising:
a step in which the reward payment step pays the reward before the store evaluation and the mobile application provides the user interface for the store evaluation to the user when there is a request from the user within a certain period of time from the time the evaluation authority is granted; and
a step in which the management server imposes a penalty on the user when the store evaluation results are not uploaded within a certain period of time.
